(19) United States
(12) Patent Application Publication
(10) Pub. No.: US 2021/0014643 A1
(43) Pub. Date: Jan. 14, 2021

(54) COMMUNICATION CONTROL DEVICE, COMMUNICATION CONTROL METHOD, AND COMPUTER PROGRAM

(71) Applicant: Sumiltomo Electric Industries, Ltd., Osaka-shi (JP)

(72) Inventors: Shinsuke KURODA, Osaka-shi (JP); Koichi TAKAYAMA, Osaka-shi (JP); Shingo OHASHI, Osaka-shi (JP)

(73) Assignee: Sumiltomo Electric Industries, Ltd., Osaka-shi (JP)

(21) Appl. No.: 16/613,139

(22) PCT Filed: Mar. 27, 2018
(86) PCT No.: PCT/JP2018/012508

§ 371 Date: Nov. 13, 2019

(30) Foreign Application Priority Data
May 30, 2017 (JP) 2017-106722

(51) Int. Cl. H04W 4/029; H04W 4/02; H04W 40/18; H04W 76/10; G01C 21/34; G05D 1/00

(52) U.S. Cl. CPC H04W 4/029; H04W 4/027; H04W 4/026; B60W 60/0015; H04W 76/10; G01C 21/3461; G05D 1/0022; H04W 40/18

(57) ABSTRACT

Provided is a communication control device for controlling wireless communication of a mobile terminal, the device including: an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable; a prediction unit that predicts the moving route based on the movement information and predicts a communication speed of the mobile terminal on the predicted moving route based on the reception sensitivity distribution information; and a communication control unit that controls the wireless communication of the mobile terminal based on the predicted communication speed predicted by the prediction unit.

### TECHNICAL FIELD

The present invention relates to a communication control device, a communication control method, and a computer program. This application claims the priority based on Japanese Patent Application No. 2017-106722 filed on May 30, 2017, and incorporates all the contents described in the above Japanese application.

### BACKGROUND ART

There has been proposed a traffic system for notifying a driver of an own vehicle that an abnormal event has occurred in another vehicle (cf. Patent Literature 1).

Patent Literature 1 describes, as one aspect of the traffic system described above, a traffic system including: a central apparatus of a traffic control center; a plurality of roadside communication devices that communicate with the central apparatus through a dedicated line; and an in-vehicle communication device that wirelessly communicates with each roadside communication device (cf. Paragraphs [0104] to [0129] of Patent Literature 1).

In this traffic system, the central apparatus determines whether or not the behavior of each vehicle corresponds to a predetermined abnormal event based on vehicle information (traveling track) including a data generation time, a vehicle speed, a vehicle position, a traveling direction, and the like, uplinked by an in-vehicle communication device of each vehicle.

When detecting a predetermined abnormal event, the central apparatus downlinks information notifying the content, the position, and the like of the abnormal event to the in-vehicle communication device of the vehicle. The vehicle having received this information notifies the driver of the occurrence of the abnormal event. Thereby, safe driving support control is performed to deal with abnormal driving.

### CITATION LIST

### [Patent Literature]

Patent Literature 1: Japanese Unexamined Patent Publication No. 2013-109746

### SUMMARY OF INVENTION

(1) A communication control device of the present disclosure is a communication control device for controlling wireless communication of a mobile terminal, the device including: an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable; a prediction unit that predicts the moving route based on the movement information and predicts a communication speed of the mobile terminal on the predicted moving route based on the reception sensitivity distribution information; and a communication control unit that controls the wireless communication of the mobile terminal based on the predicted communication speed predicted by the prediction unit.

(6) A communication control method of the present disclosure is a communication control method for wireless communication of a mobile terminal, the method including: an acquisition step of acquiring reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable; a prediction step of predicting the moving route based on the movement information and predicting a communication speed of the mobile terminal on the predicted moving route based on the reception sensitivity distribution information; and a communication control step of controlling the wireless communication of the mobile terminal based on the predicted communication speed predicted in the prediction step.

(7) A computer program of the present disclosure is a computer program for causing a computer to perform processing of controlling wireless communication of a mobile terminal, the computer program causing the computer to function as: an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable; a prediction unit that predicts the moving route based on the movement information and predicts a communication speed of the mobile terminal on the predicted moving route based on the reception sensitivity distribution information; and a communication control unit that controls the wireless communication of the mobile terminal based on the predicted communication speed predicted by the prediction unit.

The present disclosure can be achieved not only as a device having a characteristic configuration as described above, but can also be achieved as a method having such characteristic processing as a step, and can also be achieved as a program for causing a computer to execute such a step.

Further, the present disclosure can be achieved as a semiconductor integrated circuit that achieves a part or the whole of the device.

### BRIEF DESCRIPTION OF DRAWINGS

FIG. 1 is an overall configuration diagram of a wireless communication system according to an embodiment of the present invention.

FIG. 2 is a block diagram showing an example of an internal configuration of an edge server and a core server.

FIG. 3 is a block diagram showing an example of an internal configuration of an in-vehicle device.

FIG. 4 is a block diagram showing an example of an internal configuration of a pedestrian terminal.

FIG. 5 is a block diagram showing an example of an internal configuration of a roadside sensor.

FIG. 6 is an overall configuration diagram of an information providing system according to the embodiment of the present invention.

FIG. 7 is an explanatory view showing a service case of the information providing system.

FIG. 8 is an explanatory view showing the advantages of the information providing system of the present embodiment in comparison with the conventional system.

FIG. 9 is an explanatory view showing a configuration of a base station.

FIG. 10 is a block diagram showing an example of an internal configuration of a communication control device according to the embodiment of the present invention.

FIG. 11 is an explanatory view showing an example of processing contents of the communication control device.

FIG. 12 is a flowchart showing an example of creation processing of a reception sensitivity map.

FIG. 13 is a flowchart showing an example of communication control processing of a radio-quiet area.

FIG. 14 is a flowchart showing an example of the communication control processing of the radio-quiet area.

### DESCRIPTION OF EMBODIMENT

### [Solution to Problem]

In the conventional traffic system, vehicle information is uplinked on the communication route of an in-vehicle communication device→roadside communication device→central apparatus, and information on abnormal traveling with the vehicle information as source data is downlinked on the communication route of the central apparatus→roadside communication device→in-vehicle communication device. As thus described, the central apparatus generates information useful for safe driving support control by using the vehicle information transmitted by the in-vehicle communication device as an information source, but a system is desired to be able to provide a mobile terminal with appropriate information excellent in real-time property based on information collected from more information sources.

Therefore, there has been considered an information providing system that generates information useful for the safe driving support control based on not only information derived from mobile terminals such as vehicles but also information derived from fixed terminals such as roadside sensors and wirelessly transmits the generated information from a base station to the mobile terminals.

In such an information providing system, the reception sensitivity may decrease due to the influence of a building or the like in the communication area of the base station, causing generation of a radio-quiet area in which the communication speed of the wireless communication decreases. In this case, it is desirable to be able to provide necessary information to a mobile terminal moving in the radio-quiet area.

Therefore, in view of such a conventional problem, an object of the present invention is to provide a communication control device or the like capable of providing necessary information to a mobile terminal moving in a radio-quiet area where the communication speed decreases.

### [Advantageous Effects of Disclosure]

According to the present disclosure, it is possible to provide necessary information to the mobile terminal moving in the radio-quiet area where the communication speed decreases.

### DESCRIPTION OF EMBODIMENT OF INVENTION

First, the contents of the embodiment of the present invention will be listed and described.

(1) A communication control device according to the embodiment of the present invention is a communication control device for controlling wireless communication of a mobile terminal, the device including: an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable; a prediction unit that predicts the moving route based on the movement information and predicts a communication speed of the mobile terminal on the predicted moving route based on the reception sensitivity distribution information; and a communication control unit that controls the wireless communication of the mobile terminal based on the predicted communication speed predicted by the prediction unit.

According to the communication control device, it is possible to analogize from the predicted communication speed predicted by the prediction unit that the predicted moving route of the mobile terminal includes a radio-quiet area in which the communication speed decreases. In this case, by the communication control unit controlling the wireless communication of the mobile terminal so that the mobile terminal can acquire information necessary for the mobile terminal to move in the radio-quiet area, it is possible to provide necessary information to the mobile terminal moving in the radio-quiet area.

(2) In the communication control device, when the predicted moving route includes a radio-quiet area in which the predicted communication speed is less than a first threshold defined below, it is preferable that the communication control unit connect the mobile terminal to an alternative communication medium before the mobile terminal reaches the radio-quiet area.

First threshold: a minimum required communication speed for the mobile terminal to receive safe movement support information

When the predicted communication speed of the radio-quiet area is less than the first threshold, the mobile terminal cannot receive the safe movement support information in the radio-quiet area. However, in such a case, the mobile terminal can perform the wireless communication by using an alternative communication medium when moving in the radio-quiet area and can thus receive the safe driving support information without an interruption. Therefore, the safe movement support information can be reliably provided to the mobile terminal moving in the radio-quiet area.

(3) In the communication control device, when the predicted moving route includes a radio-quiet area in which the predicted communication speed is less than a first threshold defined below, it is preferable that the communication control unit notify the mobile terminal that there is a possibility of an interruption in the wireless communication, before the mobile terminal reaches the radio-quiet area.

First threshold: a minimum required communication speed for the mobile terminal to receive safe movement support information

In this case, the mobile terminal can easily learn that there is a possibility of being unable to receive the safe movement support information in the radio-quiet area.

(4) In the communication control device, when the predicted moving route includes a radio-quiet area in which the predicted communication speed is less than a first threshold defined below, the communication control unit may control the wireless communication of the mobile terminal so that the mobile terminal is able to receive the safe movement support information before the mobile terminal reaches the radio-quiet area.

First threshold: a minimum required communication speed for the mobile terminal to receive safe movement support information

When the predicted communication speed of the radio-quiet area is less than the first threshold, the mobile terminal cannot receive the safe movement support information in the radio-quiet area. However, in such a case, the mobile terminal can acquire the safe movement support information in advance before reaching the radio-quiet area, so that the safe movement support information can be reliably provided to the mobile terminal moving in the radio-quiet area.

(5) In the communication control device, when the predicted moving route includes a radio-quiet area in which the predicted communication speed is equal to or more than a first threshold defined below and less than a second threshold defined below, it is preferable that the communication control unit control the wireless communication of the mobile terminal so that the mobile terminal restricts reception of the information with a high reception priority when moving in the radio-quiet area.

First threshold: a minimum required communication speed for the mobile terminal to receive safe movement support information

Second threshold: a minimum required communication speed for the mobile terminal to receive safe movement support information and other information with a high reception priority

When the predicted communication speed in the radio-quiet area is equal to or more than the first threshold and less than the second threshold, the mobile terminal may not be able to receive the safe movement support information when preferentially receiving information with a high reception priority. However, in such a case, the mobile terminal restricts the reception of the information with a high reception priority when moving in the radio-quiet area, whereby the safe movement support information can be reliably provided to the mobile terminal moving in the radio-quiet area.

(6) A communication control method according to the embodiment of the present invention is a communication control method performed by the communication control device described above. Therefore, the communication control method of the present embodiment exhibits similar effects to the communication control device described above.

(7) A computer program according to the embodiment of the present invention is a computer program for causing a computer to function as the communication control device described above. Therefore, the computer program of the present embodiment exhibits similar effects to the communication control device described above.

### DETAILS OF EMBODIMENT OF INVENTION

Hereinafter, the embodiment of the present invention will be described in detail based on the attached drawings. Note that at least a part of the embodiment described below may be combined in a freely selected manner.

### [Overall Configuration of Wireless Communication System]

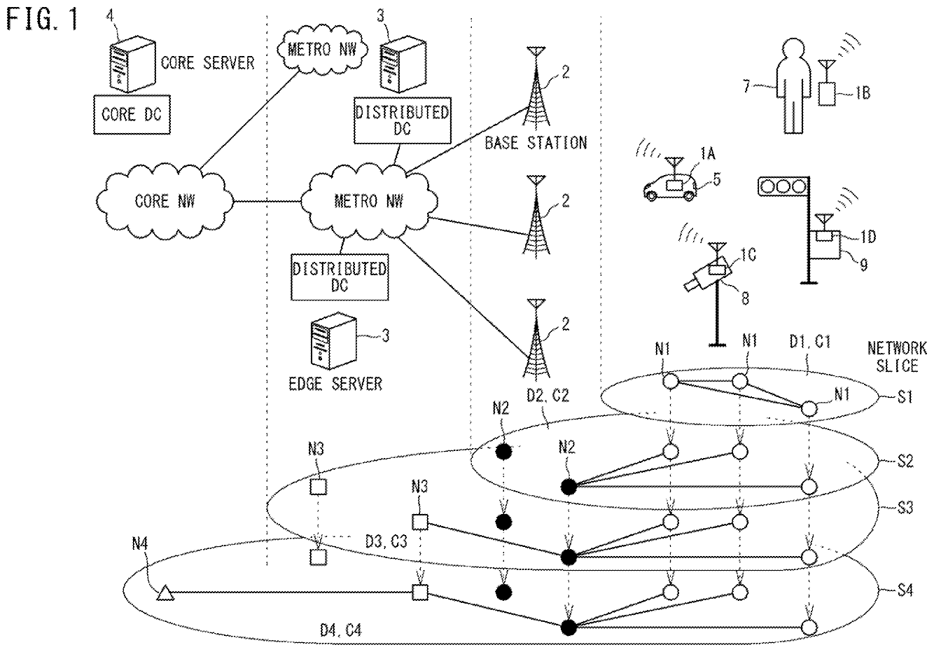

FIG. 1 is an overall configuration diagram of a wireless communication system according to the embodiment of the present invention.

As shown in FIG. 1, the wireless communication system of the present embodiment is provided with: a plurality of communication terminals 1A to 1D capable of wireless communication; one or more base stations 2 wirelessly communicating with the communication terminals 1A to 1D; one or more edge servers 3 communicating with the base station 2 in a wired or wireless manner; and one or more core servers 4 communicating with the edge server 3 in a wired or wireless manner.

The core server 4 is installed in a core data center (DC) of the core network. The edge server 3 is installed in a distributed data center (DC) of a metro network.

The metro network is, for example, a communication network established for each city. A metro network for each place is connected to the core network.

The base station 2 is communicably connected to any edge server 3 of the distributed data center included in the metro network.

The core server 4 is communicably connected to the core network. The edge server 3 is communicably connected to the metro network. Therefore, via the core network and the metro network, the core server 4 can communicate with the edge server 3 and the base station 2 belonging to the metro network in each place.

The base station 2 is made of at least one of a macro-cell base station, a micro-cell base station, and a picocell base station.

In the wireless communication system of the present embodiment, the edge server 3 and the core server 4 are made of general-purpose servers capable of software-defined networking (SDN). The base station 2 and a relay device such as a repeater (not shown) are made of transport equipment capable of SDN.

Therefore, with the network virtualization technology, it is possible to define, as physical equipment of the wireless communication system, a plurality of virtual networks (network slices) S1 to S4 that satisfy conflicting service requirements, such as low-delay communication and large-capacity communication.

The network virtualization technology described above is a basic concept of the “fifth-generation mobile communication system” (hereinafter abbreviated as “5G” (Fifth Generation)) the standardization of which is currently underway. Therefore, the wireless communication system of the present embodiment is made of 5G, for example.

However, the wireless communication system of the present embodiment only needs to be a mobile communication system capable of defining the plurality of network slices (hereinafter also referred to as “slices”) S1 to S4 in accordance with predetermined service requirements, such as delay time, and is not limited to 5G. Further, the number of layers of the slices to be defined is not limited to four but may be five or more.

In the example of FIG. 1, each of the network slice S1 to S4 is defined as follows.

The slice S1 is a network slice defined such that the communication terminals 1A to 1D communicate directly. The communication terminals 1A to 1D, which directly communicate in the slice S1, are also referred to as a “node N1.”

The slice S2 is a network slice defined such that the communication terminals 1A to 1D communicate with the base station 2. The highest communication node in the slice S2 (the base station 2 in the illustrated example) is also referred to as a “node N2.”

The slice S3 is a network slice defined such that the communication terminals 1A to 1D communicate with the edge server 3 via the base station 2. The highest communication node in the slice S3 (the edge server 3 in the illustrated example) is also referred to as a “node N3.” In the slice S3, the node N2 is a relay node. That is, the data communication is performed by the uplink route of the node N1→node N2→node N3 and the downlink route of the node N3→node N2→node N1.

The slice S4 is a network slice defined such that the communication terminals 1A to 1D communicate with the core server 4 via the base station 2 and the edge server 3. The highest communication node in the slice S4 (the core server 4 in the illustrated example) is also referred to as a “node N4.”

In the slice S4, the node N2 and the node N3 become relay nodes. That is, the data communication is performed by the uplink route of node N1→node N2→node N3→node N4 and the downlink route of node N4→node N3→node N2→node N1.

In the slice S4, the edge server 3 may not be used as the relay node in routing. In this case, the data communication is performed by the uplink route of node N1→node N2→node N4 and the downlink route of node N4→node N2→node N1.

When a plurality of base stations 2 (nodes N2) are included in the slice S2, routing for tracing the communication between the base stations 2 and 2 is also possible.

Similarly, when a plurality of edge servers 3 (nodes N3) are included in the slice S3, routing for tracing the communication between the edge servers 3 and 3 is also possible. When a plurality of core servers 4 (nodes N4) are included in the slice S4, routing for tracing the communication between the core servers 4 and 4 is also possible.

The communication terminal 1A is made of a wireless communication device mounted on a vehicle 5. The vehicles 5 include not only ordinary passenger cars but also public vehicles such as a route bus and an emergency vehicle. The vehicle 5 may be a two-wheeled vehicle (bike) as well as a four-wheeled vehicle.

The drive system of the vehicle 5 may be any of an engine drive, an electric motor drive, and a hybrid system. The driving mode of the vehicle 5 may be either normal driving in which a driver performs operations such as acceleration/deceleration and steering or automatic driving in which the software executes the operations.

The communication terminal 1A of the vehicle 5 may be a wireless communication device already installed in the vehicle 5 or a portable terminal carried by the driver into the vehicle 5.

The portable terminal of the driver temporarily becomes an in-vehicle wireless communication device by being connected to a vehicle internal local area network (LAN) of the vehicle 5.

The communication terminal 1B is a portable terminal carried by a pedestrian 7. The pedestrian 7 is a person who walks on the outdoors such as a road or a parking lot and indoors such as in a building or an underground mall. The pedestrians 7 include not only a walking person but also a person riding on a bicycle without a power source.

The communication terminal 1C is a wireless communication device mounted on a roadside sensor 8. The roadside sensor 8 includes an image-type vehicle sensor installed on a road and a security camera installed outdoors or indoors. The communication terminal 1D is a wireless communication device mounted on a traffic signal controller 9 at an intersection.

The service requirements of the slices S1 to S4 are as follows. Delay times D1 to D4 permitted for the slices S1 to S4 are defined such that D1<D2<D3<D4. For example, D1=1 ms, D2=10 ms, D3=100 ms, and D4=1 s.

Data communication amounts C1 to C4 per predetermined period (e.g., one day) permitted for the slices S1 to S4 are defined such that C1<C2<C3<C4. For example, C1=20 GB, C2=100 GB, C3=2 TB, and C4=10 TB.

As described above, in the wireless communication system of FIG. 1, the direct wireless communication in the slice S1 (e.g., “vehicle-to-vehicle communication” in which the communication terminal 1A of the vehicle 5 communicates directly, etc.) and the wireless communication via the base station 2 in the slice S2 are possible.

However, in the present embodiment, an information providing service is assumed for users included in a relatively wide service area (e.g., an area including municipalities and prefectures) using the slice S3 and the slice S4 in the wireless communication system of FIG. 1.

### [Internal Configuration of Edge Server and Core Server]

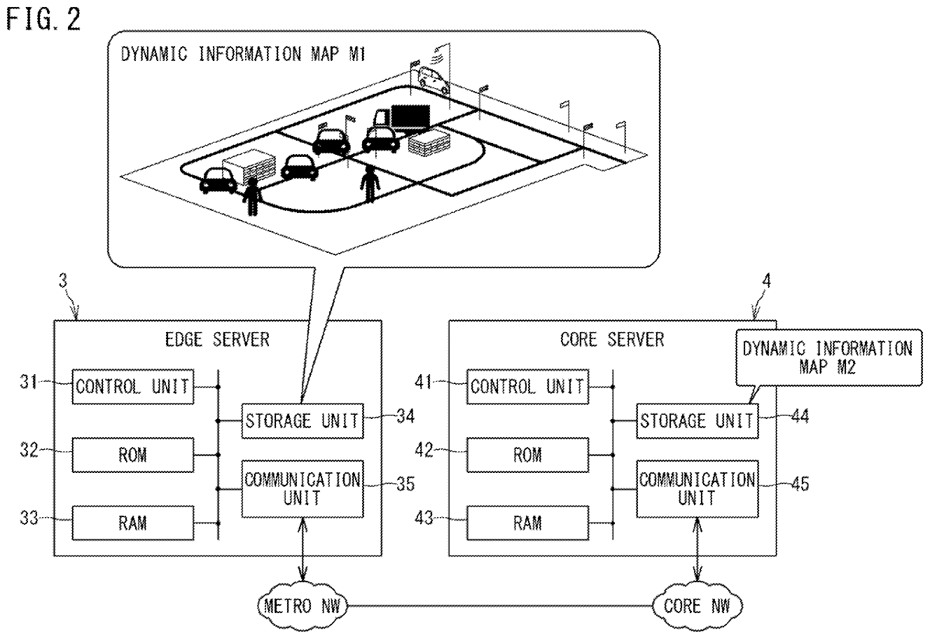

FIG. 2 is a block diagram showing an example of the internal configuration of the edge server 3 and the core server 4.

As shown in FIG. 2, the edge server 3 is provided with a control unit 31 including a central processing unit (CPU), a read-only memory (ROM) 32, a random-access memory (RAM) 33, a storage unit 34, a communication unit 35, and the like.

The control unit 31 reads out one or more programs stored in advance in the ROM 32 to the RAM 33 and executes the program to control the operation of each hardware, and the control unit 31 functions as the edge server 3 capable of communicating a computer device with the core server 4.

The RAM 33 is formed of a volatile memory element such as a static RAM (SRAM) or a dynamic RAM (DRAM) and temporarily stores the program executed by the control unit 31 and data necessary for the execution.

The storage unit 34 is formed of a non-volatile memory element such as a flash memory or an electrically erasable programmable read-only memory (EEPROM) or a magnetic storage device such as a hard disk. The storage unit 34 stores a computer program for communication control performed by the control unit 31, and the like.

The communication unit 35 is made of a communication device that performs communication processing compatible with 5G and communicates with the core server 4, the base station 2, and the like via the metro network. The communication unit 35 transmits the information given from the control unit 31 to an external device via the metro network and gives the received information to the control unit 31 via the metro network.

As shown in FIG. 2, the storage unit 34 of the edge server 3 stores a dynamic information map M1 (hereinafter also simply referred to as “map M1”).

The map M1 is a collection (virtual database) of data in which dynamic information that changes from moment to moment is superimposed on a high-definition digital map that is static information. The digital information constituting the map M1 includes “dynamic information,” “quasi-dynamic information,” “quasi-static information,” and “static information” described below.

The “dynamic information” (to one second) refers to dynamic data for which a delay time of one second or less is required. For example, positional information of a mobile body (vehicle, pedestrian, etc.) and signal information, which are used as intelligent transport systems (ITS) prefetch information correspond to the dynamic information.

The “quasi-dynamic information” (to one minute) is quasi-dynamic data for which a delay time of one minute or less is required. For example, accident information, congestion information, and narrow-area weather information correspond to the quasi-dynamic information.

The “quasi-static information” (to one hour) is quasi-static data for which a delay time of one hour or less is permitted. For example, traffic regulation information, road construction information, and wide-area weather information correspond to quasi-static information.

The “static information” (to one month) is static data for which a delay time of one month or less is required. For example, road surface information, lane information, and three-dimensional structure data correspond to static information.

The control unit 31 of the edge server 3 updates the dynamic information of the map M1 stored in the storage unit 34 at each predetermined update cycle (dynamic information update processing).

Specifically, the control unit 31 collects various pieces of measured information measured by the vehicle 5 and the roadside sensor 8 in the service area of the own device from the communication terminals 1A to 1D compatible with 5G at each predetermined update cycle and updates the dynamic information of the map M1 based on the collected measured information.

When receiving a request message for dynamic information from each of the communication terminals 1A, 1B of a predetermined user, the control unit 31 distributes the latest dynamic information to each of the communication terminals 1A, 1B of the transmission source of the request message at each predetermined distribution cycle (distribution processing of dynamic information).

The control unit 31 collects traffic information and weather information of each place in the service area from the traffic control center, a private weather service support center, and the like, and based on the collected information, the control unit 31 updates the quasi-dynamic information and the quasi-static information of the map M1.

As shown in FIG. 2, the core server 4 is provided with a control unit 41 including a CPU and the like, a ROM 42, a RAM 43, a storage unit 44, a communication unit 45, and the like.

The control unit 41 reads out one or more programs stored in advance in the ROM 42 to the RAM 43 and executes the program to control the operation of each hardware, and the control unit 41 functions as the core server 4 capable of communicating a computer device with the edge server 3.

The RAM 43 is formed of a volatile memory element such as a static RAM (SRAM) or a dynamic RAM (DRAM) and temporarily stores the program executed by the control unit 41 and data necessary for the execution.

The storage unit 44 is formed of a non-volatile memory element such as a flash memory or an EEPROM or a magnetic storage device such as a hard disk.

The communication unit 45 is made of a communication device that performs communication processing compatible with 5G and communicates with the edge server 3, the base station 2, and the like via the core network. The communication unit 45 transmits the information given from the control unit 41 to the external device via the core network and gives the received information to the control unit 41 via the core network.

As shown in FIG. 2, the storage unit 44 of the core server 4 stores a dynamic information map M2 (hereinafter also simply referred to as “map M2”).

The data structure of the map M2 (a data structure including dynamic information, quasi-dynamic information, quasi-static information, and static information) is similar to that of the map M1. The map M2 may be a map of the same service area as the map M1 of the specific edge server 3 or may be a map of a wider area in which the respective maps M1 held by the plurality of edge servers 3 are integrated.

As in the case of the edge server 3, the control unit 41 of the core server 4 can perform update processing of dynamic information to update the dynamic information of the map M2 stored in the storage unit 44 and performs distribution processing of dynamic information to distribute the dynamic information in response to a request message.

That is, the control unit 41 can independently perform the update processing and the distribution processing of the dynamic information based on the map M2 of the own device, separately from the edge server 3.

However, the core server 4 belonging to the slice S4 has a larger delay time of the communication with the communication terminals 1A to 1D than the edge server 3 belonging to the slice S3.

Therefore, even if the core server 4 independently updates the dynamic information of the map M2, the updated information is inferior in the real-time property to the dynamic information of the map M1 managed by the edge server 3. Therefore, it is preferable that the control unit 31 of the edge server 3 and the control unit 41 of the core server 4 process the update processing and the distribution processing of the dynamic information in a dispersive manner in accordance with the priority defined for each predetermined area, for example.

The control unit 41 collects traffic information and weather information of each place in the service area from the traffic control center, a private weather service support center, and the like, and based on the collected information, the control unit 41 updates the quasi-dynamic information and the quasi-static information of the map M2.

The control unit 41 may adopt the quasi-dynamic information and quasi-static information of the map M1 received from the edge server 3 as quasi-dynamic information and quasi-static information of the map M2 for the own device.

### [Internal Configuration of In-Vehicle Device]

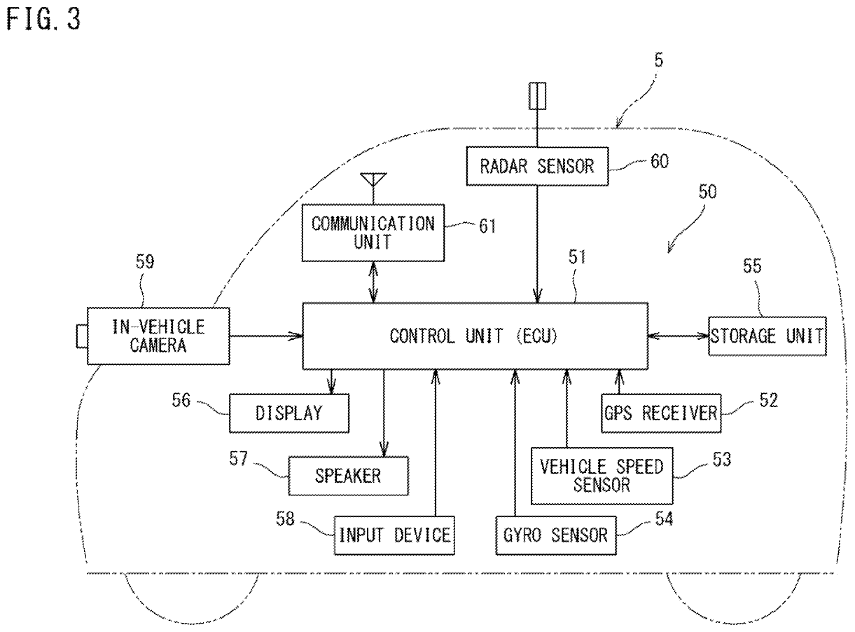

FIG. 3 is a block diagram showing an example of the internal configuration of an in-vehicle device 50.

As shown in FIG. 3, the in-vehicle device 50 of the vehicle 5 is provided with a control unit (electronic control unit (ECU)) 51, a global positioning system (GPS) receiver 52, a vehicle speed sensor 53, a gyro sensor 54, a storage unit 55, a display 56, a speaker 57, an input device 58, an in-vehicle camera 59, a radar sensor 60, a communication unit 61, and the like.

The communication unit 61 is made of the communication terminal 1A described above, that is, the wireless communication device capable of communication processing compatible with 5G, for example.

Therefore, the vehicle 5 can communicate with the edge server 3 as a type of mobile terminal belonging to the slice S3. The vehicle 5 can also communicate with the core server 4 as a type of mobile terminal belonging to the slice S4.

The control unit 51 is made of a computer device that performs route search for the vehicle 5 and controls the other electronic devices 52 to 61. The control unit 51 obtains the vehicle position of the own vehicle by using the GPS signal periodically acquired by the GPS receiver 52.

The control unit 51 complements the position and orientation of the vehicle based on the input signals of the vehicle speed sensor 53 and the gyro sensor 54 and learns the accurate current position and orientation of the vehicle 5.

The GPS receiver 52, the vehicle speed sensor 53, and the gyro sensor 54 are sensors for measuring the current position, speed, and orientation of the vehicle 5.

The storage unit 55 includes a map database. The map database provides the control unit 51 with road map data. The road map data includes link data and node data and is stored in a recording medium such as a DVD, a CD-ROM, a memory card, or an HDD. The storage unit 55 reads out necessary road map data from the recording medium and provides the control unit 51 with the road map data.

The display 56 and the speaker 57 are output devices for notifying the user who is the driver of the vehicle 5 of various pieces of information generated by the control unit 51.

Specifically, the display 56 displays an input screen for route search, a map image around the vehicle, route information to a destination, and the like. The speaker 57 outputs a voice such as an announcement for guiding the vehicle 5 to the destination. These output devices can also notify the driver of the provided information received by the communication unit 61.

The input device 58 is a device for the driver of the vehicle 5 to perform various input operations. The input device 58 is made of a combination of an operation switch provided on a steering wheel, a joystick, and a touch panel provided on the display 56.

A voice recognition device that accepts input by recognizing the voice of the driver may be used as the input device 58. An input signal generated by the input device 58 is transmitted to the control unit 51.

The in-vehicle camera 59 is an image sensor for capturing an image in front of the vehicle 5. The in-vehicle camera 59 may be either a single eye or a compound eye. The radar sensor 60 is made of a sensor that detects an object present in front of or around the vehicle 5 by a millimeter-wave radar, a LiDAR method, or the like.

The control unit 51 can perform safe driving support control that causes the display 56 to output a warning for the driver while driving or performs forced braking intervention based on measurement data by the in-vehicle camera 59 and the radar sensor 60.

The control unit 51 is formed of an arithmetic processing unit, such as a microcomputer, which executes various control programs stored in the storage unit 55.

The control unit 51 can perform various navigation functions such as a function of displaying a map image on the display 56 by executing the control program, a function of calculating a route from a departure place to a destination (if there is a relay point, the route includes the position of the route), and a function of guiding the vehicle 5 to the destination in accordance with the calculated route.

Based on measurement data of at least one of the in-vehicle camera 59 and the radar sensor 60, the control unit 51 can perform an object recognition processing for recognizing an object in front of or around the own vehicle and distance measurement processing for calculating a distance to the recognized object.

The control unit 51 can calculate the positional information of the object recognized by the object recognition processing from the distance calculated by the distance measurement processing and the sensor position of the own vehicle.

The control unit 51 can perform each processing below in communication with the edge server 3 (which may be the core server 4).
1) Transmission processing of request message
2) Reception processing of dynamic information
3) Calculation processing of change point information
4) Transmission processing of change point information

The transmission processing of the request message is the processing of transmitting to the edge server 3 a control packet that requests the distribution of the dynamic information of the map M1 sequentially updated by the edge server 3. The control packet includes the vehicle ID of the own vehicle.

When receiving the request message including a predetermined vehicle ID, the edge server 3 distributes, at a predetermined cycle, the dynamic information distribution to the communication terminal 1A of the vehicle 5 having the vehicle ID of the transmission source.

The reception processing of the dynamic information is the processing of receiving the dynamic information distributed by the edge server 3 to the own device.

The calculation processing of the change point information in the vehicle 5 is the processing of calculating the amount of change between the received dynamic information and the measured information of the own vehicle at the time of reception, from the result of comparison between those pieces of information. As the change point information calculated by the vehicle 5, for example, the following information examples a1 to a2 can be considered.

### INFORMATION EXAMPLE a1

### Change Point Information on a Recognized Object

When the control unit 51 detects an object X (vehicle, pedestrian, obstacle, etc.) by the object recognition processing of its own although the received dynamic information does not include the object X, the control unit 51 takes the image data and the positional information of the detected object X as the change point information.

When the positional information of the object X included in the received dynamic information and the positional information of the object X obtained by the object recognition processing of its own deviate from each other by a predetermined threshold or more, the control unit 51 takes the image data of the detected object X and the value of difference in positional information therebetween as the change point information.

### INFORMATION EXAMPLE a2

### Change Point Information on the Own Vehicle

When the positional information of the own vehicle included in the received dynamic information and the vehicle position of the own vehicle calculated by the unit 51 itself using the GPS signal deviate from each other by the predetermined threshold or more, the control unit 51 takes the value of the difference therebetween as the change point information.

When the orientation of the own vehicle included in the received dynamic information and the orientation of the own vehicle calculated by the unit 51 itself from the measurement data of the gyro sensor 54 deviate from each other by a predetermined threshold or more, the control unit 51 takes the value of difference therebetween as the change point information.

When calculating the change point information as described above, the control unit 51 generates a communication packet addressed to the edge server 3, including the calculated change point information. The control unit 51 includes the vehicle ID of the own vehicle in the communication packet.

The transmission processing of the change point information is the processing of transmitting to the edge server 3 the above communication packet with the change point information included in the data. The transmission processing of the change point information is performed within the cycle of the distribution of the dynamic information by the edge server 3.

The control unit 51 can perform safe driving support control that causes the display 56 to output a warning for the driver while driving or performs forced braking intervention based on the dynamic information received from the edge server 3 or the like.

### [Internal Configuration of Pedestrian Terminal]

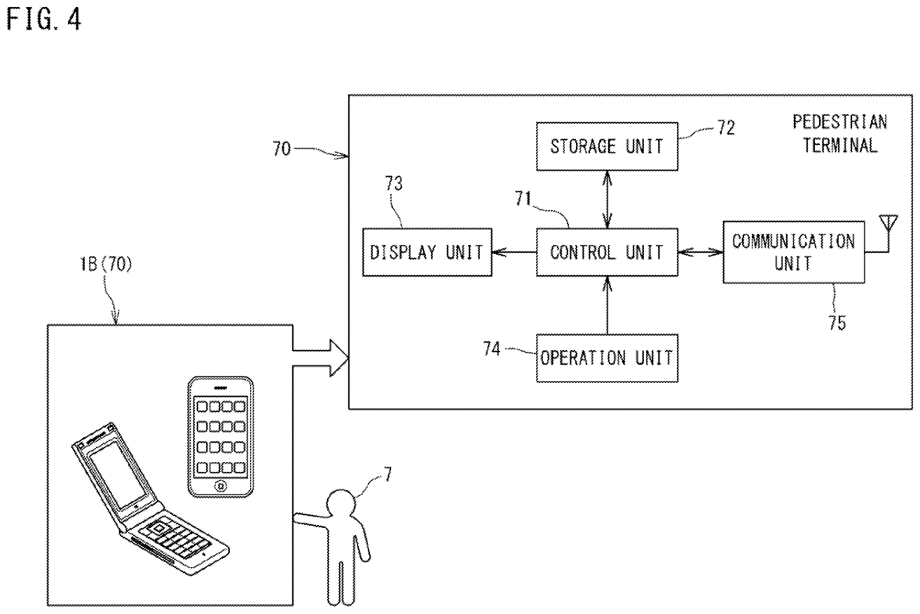

FIG. 4 is a block diagram showing an example of the internal configuration of a pedestrian terminal 70.

The pedestrian terminal 70 of FIG. 4 is made of the communication terminal 1B described above, that is, the wireless communication device capable of communication processing compatible with 5G, for example.

Therefore, the pedestrian terminal 70 can communicate with the edge server 3 as a type of mobile terminal belonging to the slice S3. The pedestrian terminal 70 can also communicate with the core server 4 as a type of mobile terminal belonging to the slice S4.

As shown in FIG. 4, the pedestrian terminal 70 is provided with a control unit 71, a storage unit 72, a display unit 73, an operation unit 74, and a communication unit 75.

The communication unit 75 is made of a communication interface wirelessly communicating with the base station 2 of the carrier that provides the 5G service. The communication unit 75 converts an RF signal from the base station 2 into a digital signal and outputs the digital signal to the control unit 71, and the communication unit 75 converts a digital signal input from the control unit 71 into an RF signal and transmits the RF signal to the base station 2.

The control unit 71 includes a CPU, a ROM, a RAM, and the like. The control unit 71 reads out the program stored in the storage unit 72 and executes the program to control the overall operation of the pedestrian terminal 70.

The storage unit 72 is formed of a hard disk, a non-volatile memory, or the like, and stores various computer programs and data. The storage unit 72 stores a mobile ID being identification information of the pedestrian terminal 70. The mobile ID is, for example, a unique user ID of a carrier contractor, a media access control (MAC) address, or the like.

The storage unit 72 stores various application software installed by the user in a freely selected manner.

The application software includes, for example, application software for enjoying an information providing service for receiving dynamic information and the like of the map M1 by the 5G communication with the edge server 3 (or the core server 4).

The operation unit 74 is formed of various operation buttons and a touch panel function of the display unit 73. The operation unit 74 outputs an operation signal corresponding to the user's operation to the control unit 71.

The display unit 73 is made of, for example, a liquid crystal display and presents various pieces of information to the user. For example, the display unit 73 can display on the screen the image data of the dynamic information maps M1, M2 transmitted from the servers 3, 4.

The control unit 71 has a time synchronization function to acquire the current time from the GPS signal, a position detection function to measure the current position (latitude, longitude, and altitude) of the own vehicle from the GPS signal, an orientation detection function to measure the orientation of the pedestrian 7 with an orientation sensor, and some other functions.

The control unit 71 can perform each processing below in communication with the edge server 3 (which may be the core server 4).
1) Transmission processing of request message
2) Transmission processing of terminal status information
3) Dynamic information reception processing

The transmission processing of the request message is the processing of transmitting to the edge server 3 a control packet that requests the distribution of the dynamic information of the map M1 sequentially updated by the edge server 3. The control packet includes the mobile ID of the pedestrian terminal 70.

When receiving the request message including a predetermined mobile ID, the edge server 3 distributes, at a predetermined cycle, the dynamic information distribution to the communication terminal 1B of the pedestrian 7 having the mobile ID of the transmission source.

The transmission processing of the terminal state information is the processing of transmitting to the edge server 3 the state information of the pedestrian terminal 70, such as the position and orientation information of the own device. The terminal state information may include identification information indicating whether or not application software that easily causes a so-called “smartphone zombie,” such as a map application, a mail application, and a game application, is being displayed.

The reception processing of the dynamic information is the processing of receiving the dynamic information distributed by the edge server 3 to the own device.

### [Internal Configuration of Roadside Sensor]

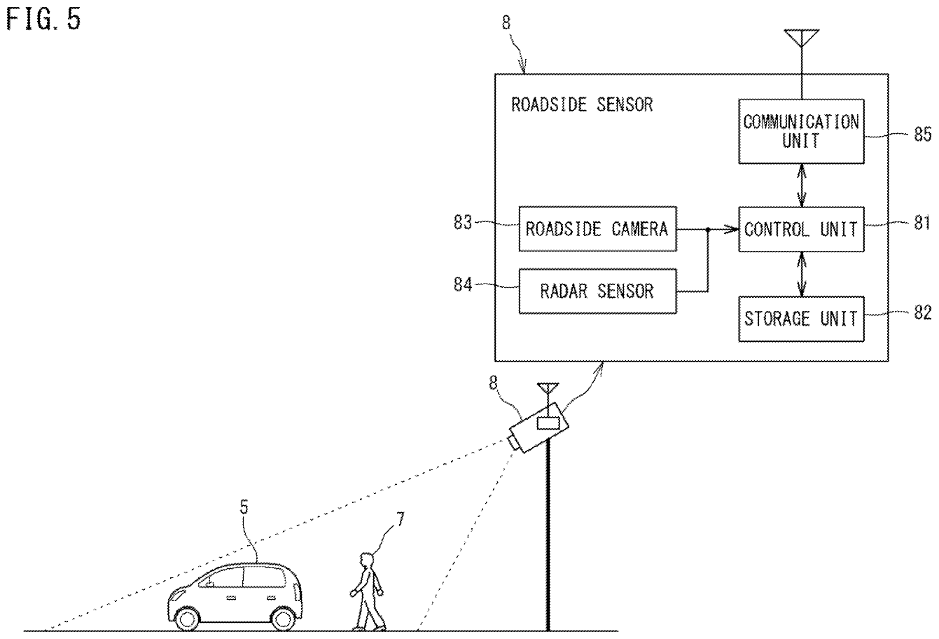

FIG. 5 is a block diagram showing an example of the internal configuration of the roadside sensor 8.

As shown in FIG. 5, the roadside sensor 8 is provided with a control unit 81, a storage unit 82, a roadside camera 83, a radar sensor 84, and a communication unit 85.

The communication unit 85 is made of the communication terminal 1C described above, that is, the wireless communication device capable of communication processing compatible with 5G, for example.

Therefore, the roadside sensor 8 can communicate with the edge server 3 as a type of fixed terminal belonging to the slice S3. The roadside sensor 8 can also communicate with the core server 4 as a type of fixed terminal belonging to the slice S4.

The control unit 81 includes a CPU, a ROM, a RAM, and the like. The control unit 81 reads out the program stored in the storage unit 82 and executes the program to control the overall operation of the roadside sensor 8.

The storage unit 82 is formed of a hard disk, a non-volatile memory, or the like, and stores various computer programs and data. The storage unit 82 stores a sensor ID being identification information of the roadside sensor 8. The sensor ID is made of, for example, a user ID unique to the owner of the roadside sensor 8, a MAC address, or the like.

The roadside camera 83 is an image sensor for capturing an image of a predetermined imaging area. The roadside camera 83 may be either a single eye or a compound eye. The radar sensor 60 is made of a sensor that detects an object present in front of or around the vehicle 5 by a millimeter-wave radar, a LiDAR method, or the like.

When the roadside sensor 8 is a security camera, the control unit 81 transmits the captured image data and the like to a computer device of a security manager. When the roadside sensor 8 is an image type vehicle sensor, the control unit 81 transmits the captured image data and the like to the traffic control center.

Based on measurement data of at least one of the roadside camera 83 and the radar sensor 84, the control unit 81 can perform an object recognition processing for recognizing an object in the imaging area and distance measurement processing for calculating the distance to the recognized object.

The control unit 81 can calculate the positional information of the object recognized by the object recognition processing from the distance calculated by the distance measurement processing and the sensor position of the own device.

The control unit 81 can perform each processing below in communication with the edge server 3 (which may be the core server 4).
1) Calculation processing of change point information
2) Transmission processing of change point information

The calculation processing of the change point information in the roadside sensor 8 is the processing of calculating the amount of change between the previous measured information and the current measured information, from the result of comparison between those pieces of measured information at each predetermined measurement cycle (e.g., the cycle of distribution of the dynamic information by the edge server 3). As the change point information calculated by the roadside sensor 8, for example, the following information example b1 can be considered.

### INFORMATION EXAMPLE b1

### Change Point Information on the Recognition Object

When the control unit 81 detects an object Y (vehicle, pedestrian, obstacle, etc.) by the current object recognition processing although the object Y is not included in the previous object recognition processing, the control unit 81 takes the image data and the positional information of the detected object Y as the change point information.

When the positional information of the object Y obtained from the previous object recognition processing and the positional information of the object Y obtained from the current object recognition processing deviate from each other by a predetermined threshold or more, the control unit 81 takes the positional information of the detected object Y and the value of difference therebetween as the change point information.

When calculating the change point information as described above, the control unit 81 generates a communication packet addressed to the edge server 3, including the calculated change point information. The control unit 81 includes the sensor ID of the own device in the communication packet.

The transmission processing of the change point information is the processing of transmitting to the edge server 3 the above communication packet with the change point information included in the data. The transmission processing of the change point information is performed within the cycle of the distribution of the dynamic information by the edge server 3.

### [Overall Configuration of Information Providing System]

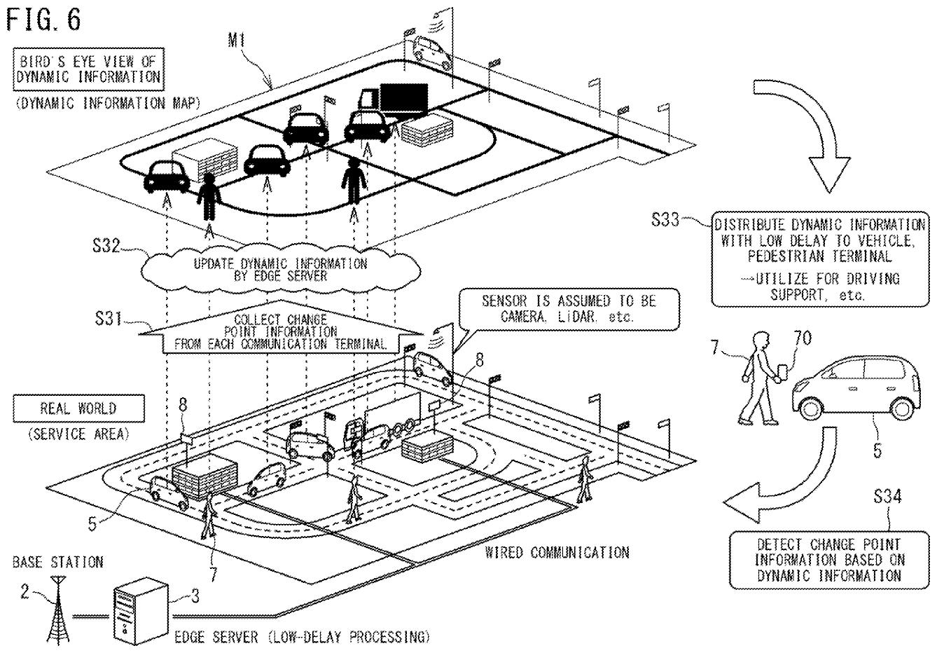

FIG. 6 is the overall configuration diagram of the information providing system according to the embodiment of the present invention.

As shown in FIG. 6, the information providing system of the present embodiment is provided with a large number of vehicles 5, pedestrian terminals 70, and roadside sensors 8 scattered in the service area (real word) of the edge server 3 which is relatively a wide range, and the edge server 3 capable of wirelessly communicating with these communication nodes with a low delay by the 5G communication via the base station 2 and the like.

The edge server 3 collects the change point information described above from the vehicle 5, the roadside sensor 8, and the like at a predetermined cycle (step S31) and integrates the collected change point information by map matching to update the dynamic information of the dynamic information map M1 under management (step S32).

If there is a request from the vehicle 5 or the pedestrian terminal 70, the edge server 3 transmits the latest dynamic information to the communication node of the request source (step S33). Thus, for example, the vehicle 5 having received the dynamic information can utilize the dynamic information for the safe driving support of the driver, and the like.

When the vehicle 5 having received the dynamic information detects the change point information with the measured information of the own vehicle based on the dynamic information, the vehicle 5 transmits the detected change point information to the edge server 3 (step S34).

As described above, in the information providing system of the present embodiment, the information processing in each communication node circulates in the order of collection of change point information (step S31), update of dynamic information (step S32), distribution of dynamic information (step S33), detection of change point information by vehicle (step S34), and collection of change point information (step S31).

Although FIG. 6 illustrates an information providing system including only one edge server 3, a plurality of edge servers 3 may be included, or one or more core servers 4 may be included instead of or in addition to the edge server 3.

The dynamic information map M1 managed by the edge server 3 only needs to be a map in which at least dynamic information of an object is superimposed on map information such as a digital map. This also applies to the case of the dynamic information map M2 of the core server.

### [Service Case of Information Providing System]

As described above, in the information providing system of the present embodiment, the edge server 3 (or the core server 4) can update substantially in real time the dynamic information of the dynamic information map M1 in accordance with the measured information (specifically, change point information) collected from the vehicle 5 and the roadside sensor 8.

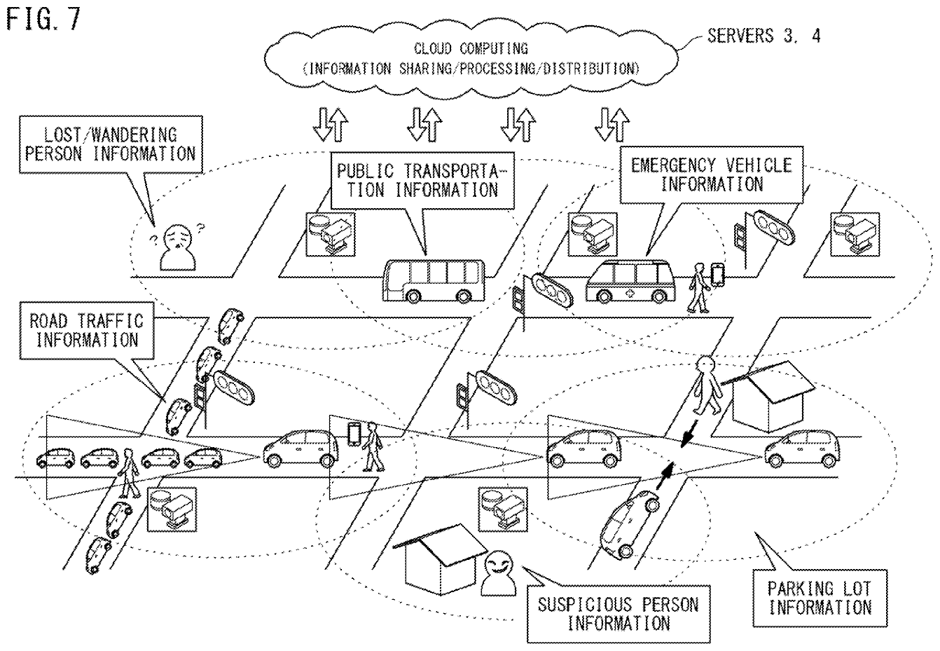

This makes it possible to provide various pieces of information to the user depending on the type of dynamic information included in the management target. FIG. 7 is an explanatory view showing a service case of the information providing system.

As shown in FIG. 7, the servers 3, 4 can provide the “lost/wandering person information” to the user.

For example, when the positional information of the pedestrian terminal 70 owned by the elderly pedestrian 7 specified from his or her mobile ID is circulating around the residence many times, the servers 3, 4 determine that the pedestrian 7 is lost or wandering and transmit the determination result to the pedestrian terminal 70 owned by the family of the pedestrian 7.

The servers 3, 4 can provide “public transportation information” to the user.

For example, when the pedestrian terminal 70 owned by the user is stopping at a bus stop, the servers 3, 4 calculate an estimated time when a route bus specified from its vehicle ID will arrive at the bus stop from the positional information of the route bus and transmit the calculated estimated time to the pedestrian terminal 70 of the user.

The servers 3, 4 can provide “emergency vehicle information” to the user.

For example, when the vehicle 5 owned by the user is traveling on a road, the servers 3, 4 calculate an estimated time at which an ambulance specified from its vehicle ID will catch up with the vehicle 5 from the positional information of the ambulance and transmit the calculated estimated time to the user's vehicle 5.

The servers 3, 4 can provide “road traffic information” to the user.

For example, when the servers 3, 4 detect congestion due to a large number of vehicles 5 present in a predetermined road section, the servers 3, 4 generate link data of the road section in the congestion and congestion information such as congestion length and transmit the generated congestion information to the vehicle 5 owned by the user.

The servers 3, 4 can provide “suspicious person information” to the user.

For example, when the positional information of the pedestrian 7 acquired from the roadside sensor 8 made of a security camera is circulating around the same residence many times, the servers 3, 4 determine that the pedestrian 7 is a suspicious person and transmit the determination result to the pedestrian terminal 70 of the user who owns the residence.

The servers 3, 4 can provide “parking lot information” to the user.

For example, from the image data acquired from the roadside sensor 8 installed in a parking lot, the servers 3, 4 calculate the number of vehicles present in the parking lot, the number of vacant spaces, and the like and transmit the calculated information to the vehicle 5 owned by the user.

### [Advantages of Information Providing System]

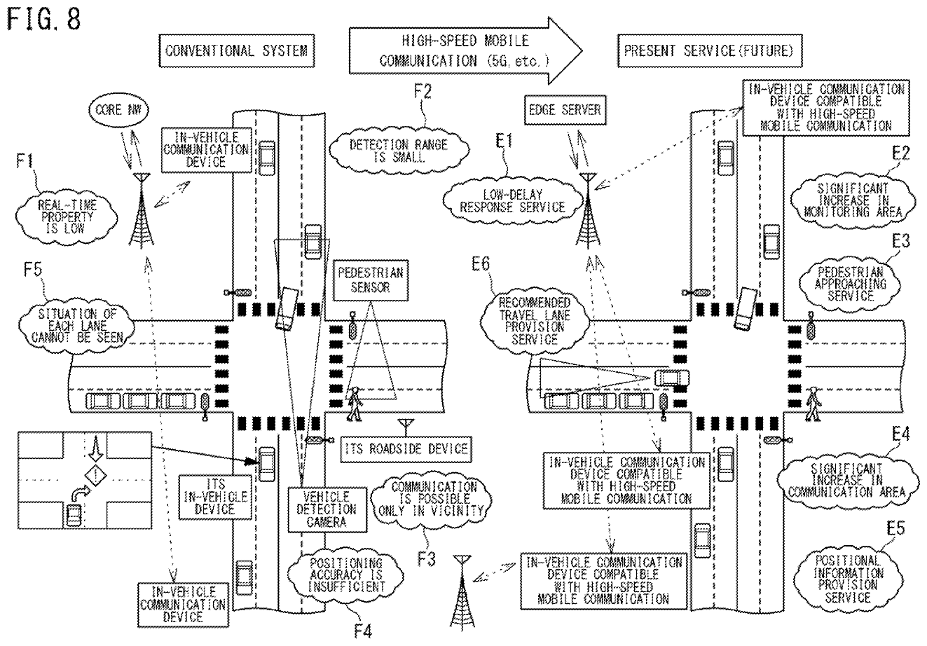

FIG. 8 is an explanatory view showing the advantages of the information providing system (hereinafter referred to as the “present system”) of the present embodiment in comparison with the conventional system.

Disadvantages F1 to F5 of the conventional system and advantages E1 to E6 of the present system will be described below with reference to FIG. 8.

In the conventional system, probe information and the like are shared by mobile communication using an in-vehicle communication device such as an in-vehicle telematics communication unit (TCU). However, mobile communication of up to 4G has a disadvantage that real-time property is low (cf. F1) because mobile communication is performed via the core network.

In contrast, in the present system, since the vehicle 5 has the communication terminal 1A compatible with high-speed mobile communication such as 5G, for example, there is an advantage that low delay response service (cf. E1) via the edge server 3 can be provided to the driver of the vehicle 5.

In the conventional system, the presence or absence of a pedestrian is detected by a pedestrian sensor. However, the pedestrian sensor is disposed only locally at a location where many pedestrians pass, such as pedestrian crossings, and has a disadvantage that the pedestrian detection range is small (cf. F2).

In contrast, in the present system, the dynamic information including the positional information of the pedestrian 7 is updated from the measured information measured by the vehicle 5 and the roadside sensor 8 included in the service area of the edge server 3. Therefore, there is an advantage that the pedestrian approaching service (cf. E3) can be provided to the user while the monitoring area is expanded significantly (cf. E2).

In the conventional system, in the case of an ITS-compatible vehicle, wireless communication can be performed with an ITS roadside device operated by a road manager. However, the communication range of the ITS roadside device is about 200 m from the intersection, and there is a disadvantage that communication can be performed only near the intersection (cf. F3).

In contrast, in the present system, the edge server 3 collects information in the service area and distributes dynamic information by the wireless communication. Hence there is an advantage of a significant increase in communication area (cf. E4).

In the conventional system, the number of vehicles and the vehicle positions in the vicinity of the intersection can be detected by a vehicle detection camera or the like installed on a road. However, there is a disadvantage that with the vehicle detection camera alone, the positioning accuracy in positional information of the vehicles and the like is insufficient (cf. F4).

In contrast, in the present system, the positional information of the same object can be corrected by the measured information collected from the plurality of vehicles 5 and the roadside sensor 8. Hence there is an advantage that the provision service of accurate positional information (cf. E5) can be achieved.

In the conventional system, it is possible to estimate, for example, the number of vehicles stopping on a road, based on probe information and the like transmitted by ITS-compatible vehicles. However, the loading rate of the ITS in-vehicle device cannot yet be said to be large, and hence there is a disadvantage that the situation of each lane cannot be seen (cf. F5).

In contrast, in the present system, the dynamic information managed by the edge server 3 includes measured information from the in-vehicle camera 59. For this reason, there is an advantage that the traffic volume for each lane can be learned, and service to provide a recommended travel lane (cf. E6) can be achieved.

### [Radio-Quiet Area]

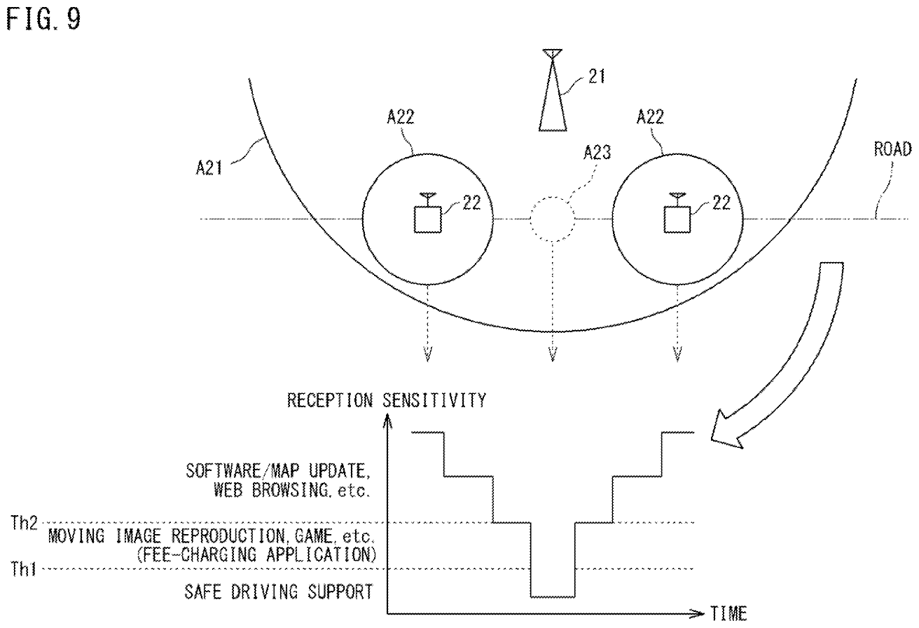

FIG. 9 is an explanatory view showing the configuration of the base station 2. The base station 2 of the present embodiment includes a macro-cell base station 21 and a plurality of small cell base stations 22.

The macro-cell base station 21 forms, for example, a communication area A21 having a radius of several hundred meters.

The plurality of small cell base stations 22 are each made of at least one of a micro-cell base station and a picocell base station and are disposed in the communication area A21 of the macro-cell base station 21.

Each small cell base station 22 forms, for example, a communication area A22 having a radius of several tens of meters.

In the communication area A21 of the macro-cell base station 21, the vehicle 5 and the pedestrian terminal 70 can perform the 5G communication with the macro-cell base station 21 or the small cell base station 22.

In the communication area A21 of the macro-cell base station 21, for example, a radio-quiet area A23 may be generated between the two communication areas A22 of the adjacent small cell base stations 22. The radio-quiet area A23 is an area in which the reception sensitivity of the 5G communication decreases due to, for example, the shadow of a building. When a large number of vehicles 5 and pedestrian terminals 70 perform the 5G communication in such a radio-quiet area A23, the communication speed decreases.

FIG. 9 shows a change in communication speed when the communication speed decreases in the radio-quiet area A23 on a virtual straight road passing the center of the radio-quiet area A23 and the center of each of the adjacent communication areas A22.

As shown in FIG. 9, the communication speed is highest (e.g., 10 Mbps) at the center of each communication area A22, the communication speed gradually decreases from the center of each communication area A22 toward the center of the radio-quiet area A23., and the communication speed is lowest (e.g., 100 Kbps) at the center of the radio-quiet area A23.

In FIG. 9, the communication speed in the radio-quiet area 23A is less than a first threshold Th1. The first threshold Th1 is the minimum communication speed required for the vehicle 5 to receive safe driving support information (safe movement support information) used for the safe driving support control. The safe driving support information includes, for example, signal information of one cycle before an intersection, approach information in which another vehicle approaches the own vehicle at a distance of 50 m or less, and some other information.

In FIG. 9, the communication speed between the radio-quiet area 23A and each communication area A22 is a second threshold Th2 that is a value larger than the first threshold Th1. The second threshold Th2 is the minimum communication speed required to receive the safe driving support information and other information with a high reception priority. Examples of the information with a high reception priority may include paid application software (moving image reproduction, game, etc.).

In FIG. 9, the communication speed in each communication area A22 exceeds the second threshold Th2. When the communication speed exceeds the second threshold Th2, it is possible to receive other information necessary for using application software, updating map information, browsing a web browser, and the like.

Therefore, the vehicle 5 traveling in the communication area A22 can receive the safe driving support information, the information with a high reception priority, and other information without any problem.

In contrast, since the communication speed in the radio-quiet area 23A is less than the first threshold Th1 that is the minimum necessary to receive the safe driving support information, the vehicle 5 traveling in the radio-quiet area 23A cannot receive the safe driving support information.

Further, when the communication speed in the radio-quiet area 23A is less than the second threshold Th2 even if the communication speed in the radio-quiet area 23A is equal to or more than the first threshold Th1, the vehicle 5 may not be able to receive the safe driving support information when preferentially receiving the information with a high reception priority.

Therefore, in the communication area 21 of the base station 2, the edge server 3 according to the present embodiment functions as a communication control device that controls the wireless communication of the vehicle 5 traveling in the radio-quiet area 23 so as to be able to provide the vehicle 5 with information necessary for the safe driving support information.

### [Internal Configuration of Communication Control Device]

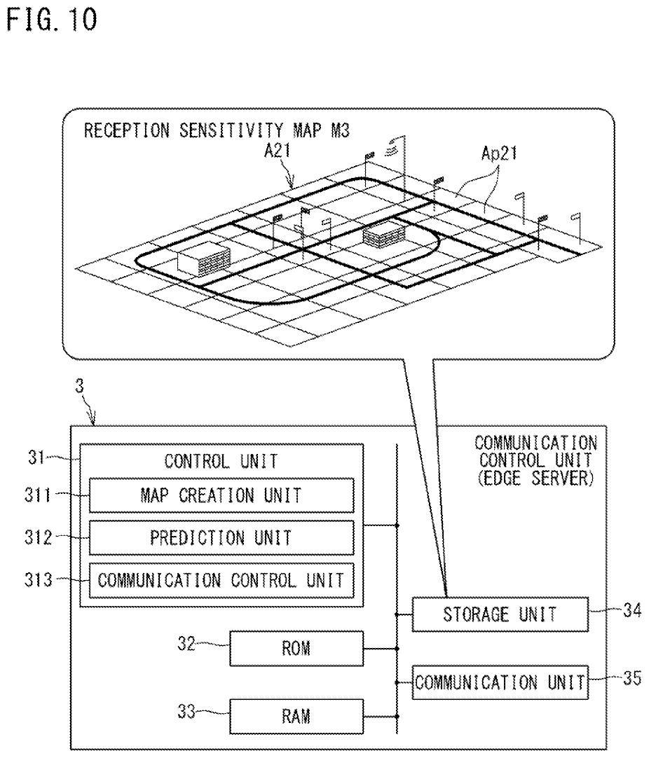

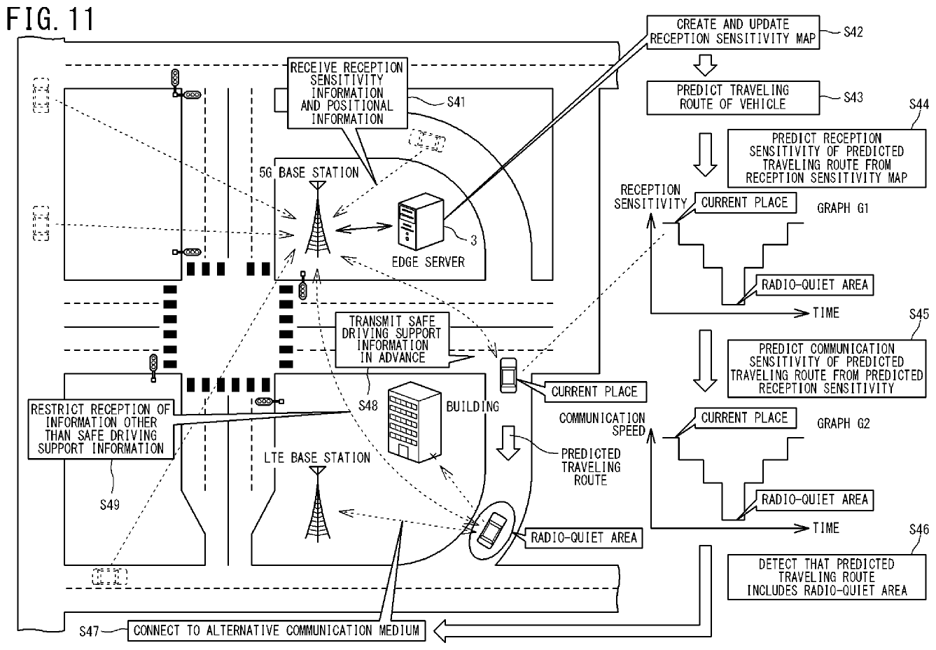

FIG. 10 is a block diagram showing an example of the internal configuration of the communication control device (edge server 3) according to the embodiment of the present invention. FIG. 11 is an explanatory view of an example of processing contents of the communication control device.

In FIGS. 10 and 11, the communication unit 35 of the edge server 3 periodically receives the positional information and the reception sensitivity information indicating the reception sensitivity of the wireless communication with the base station 2 from each of a large number of vehicles 5 scattered in the service area, via the base station 2 (step S41).

The control unit 31 of the edge server 3 includes a map creation unit 311, a prediction unit 312, and a communication control unit 313.

The map creation unit 311 creates a reception sensitivity map M3 (hereinafter also simply referred to as “map M3”) based on the positional information of the vehicle 5 and the reception sensitivity information received by the communication unit 35 and the map creation unit 311 updates the map M3 each time the communication unit 35 periodically receives the positional information and the reception sensitivity information (step S42).

The map M3 has a data structure in which the reception sensitivity for each of a plurality of partial areas (cells) Ap21 obtained by dividing the communication area A21 of the base station 2 is superimposed as dynamic information on a high-definition digital map that is static information. The map creation unit 311 stores the created map M3 into the storage unit 34 of the edge server 3 as reception sensitivity distribution information.

Although the communication unit 35 of the present embodiment receives the positional information and the reception sensitivity information from the vehicle 5, in addition to this, the communication unit 35 may also receive these pieces of information from the pedestrian terminal 70 or the roadside sensor 8. In this case, the map creation unit 311 can collect more positional information and reception sensitivity information, thereby enabling the creation of the reception sensitivity map M3 with high reliability.

The storage unit 34 also stores movement information received by the communication unit 35 from the vehicle 5. The movement information is information that can predict the traveling route (moving route) of the vehicle 5 and includes, for example, route information from a departure place to a destination, map information, and the like to be used in the navigation function of the vehicle 5.

Hence the storage unit 34 of the present embodiment functions as an acquisition unit that acquires the movement information of the vehicle 5 and the reception sensitivity distribution information.

The prediction unit 312 of the control unit 31 predicts the traveling route from the current place of the vehicle 5 based on the movement information stored in the storage unit 34 (step S43). Hereinafter, the traveling route predicted by the prediction unit 312 is referred to as a predicted traveling route (predicted moving route).

The prediction unit 312 predicts the reception sensitivity of the wireless communication on the predicted traveling route, based on the map M3 stored in the storage unit 34 (step S44). Hereinafter, the reception sensitivity predicted by the prediction unit 312 is referred to as predicted reception sensitivity.

The prediction unit 312 predicts the communication speed of the wireless communication on the predicted traveling route, based on the predicted reception sensitivity (step S45). Hereinafter, the communication speed predicted by the prediction unit 312 is referred to as a predicted communication speed.

The communication control unit 313 of the control unit 31 controls the wireless communication of the vehicle 5 based on the predicted communication speed on the predicted traveling route.

Specifically, when the predicted traveling route includes a radio-quiet area in which the predicted communication speed is less than the first threshold Th1 (step S46), the communication control unit 313 connects the vehicle 5 to an alternative communication medium other than the current communication medium (5G communication) before the vehicle 5 reaches the radio-quiet area(step S47). As an alternative communication medium, for example, communication medium such as long-term evolution (LTE) standard, vehicle-to-vehicle communication performed with another vehicle, and the like can be considered.

When the vehicle 5 cannot perform the wireless communication by using the alternative communication medium, the communication control unit 313 notifies the vehicle 5 in advance that there is a possibility of an interruption in the wireless communication. Then, the communication control unit 313 transmits the safe driving support information in advance by the wireless communication before the vehicle 5 reaches the radio-quiet area so that the vehicle 5 can perform autonomous safe driving support control without being provided the information from the edge server 3 (step S48).

On the other hand, when the predicted traveling route includes a radio-quiet area in which the predicted communication speed is equal to or more than the first threshold Th1 and less than the second threshold Th2, the communication control unit 313 controls the wireless communication of the vehicle 5 so that the vehicle 5 restricts the reception of the information with a high reception priority other than the safe driving support information (step S49).

### [Creation Processing of Reception Sensitivity Map]

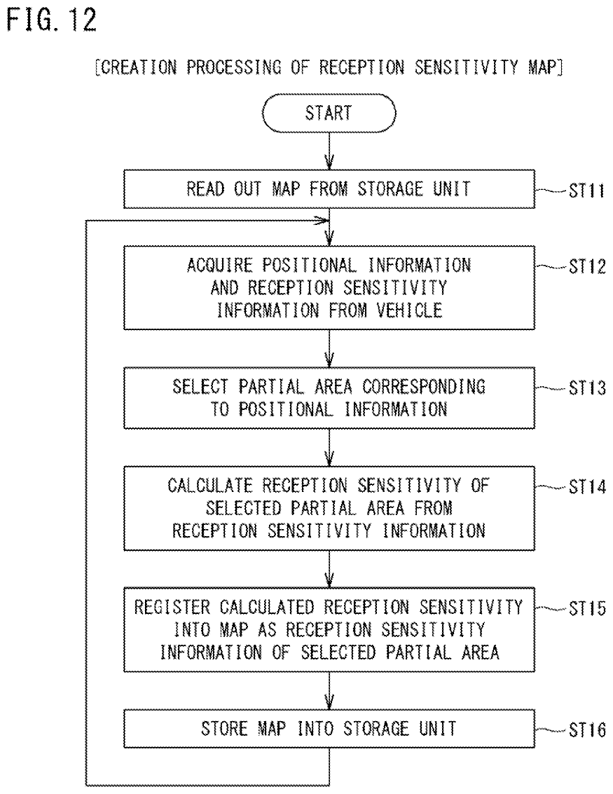

FIG. 12 is a flowchart showing an example of creation processing of the reception sensitivity map M3 performed by the edge server 3.

As shown in FIG. 12, the edge server 3 first reads out the reception sensitivity map M3 (cf. FIG. 10) stored in advance in the storage unit 34 (step ST11). The map M3 at this point is data in which the communication area A21 is only divided into a plurality of partial areas Ap21, and the reception sensitivity information of each partial area Ap21 is not included.

Next, the edge server 3 causes the communication unit 35 to acquire positional information and reception sensitivity information from the vehicle 5 traveling in the communication area A21 (step ST12).

From the acquired positional information, the edge server 3 selects the partial area Ap21 in the map M3 corresponding to the positional information (step ST13). Hereinafter, the selected partial area Ap21 is referred to as a selected partial area Ap21.

Next, the edge server 3 calculates the reception sensitivity of the selected partial area Ap21 from the acquired reception sensitivity information (step ST14). For example, the edge server 3 calculates the reception sensitivity of the selected partial area Ap21 by performing averaging processing, filtering processing, and the like on the acquired reception sensitivity information (including the past reception sensitivity information).

The edge server 3 registers the calculated reception sensitivity into the map M3 (step ST15) as the reception sensitivity information of the selected partial area Ap21 and stores the map M3 into the storage unit 34 (step ST16).

The edge server 3 repeatedly performs the processing of steps ST12 to ST16. Thus, the edge server 3 can acquire positional information and reception sensitivity information from each of a large number of vehicles 5 scattered in the communication area A21 and can thus create the reception sensitivity map M3 in which the reception sensitivity information of each of the plurality of partial areas Ap21 is registered. Then, the edge server 3 can update the reception sensitivity map M3 by periodically performing this repetitive process.

### [Communication Control Processing of Radio-Quiet Area]

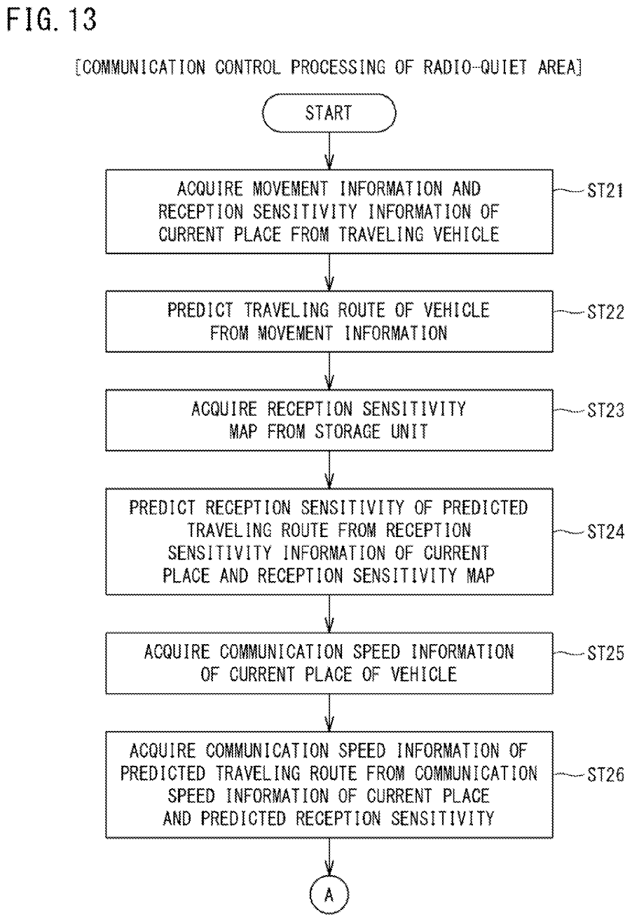

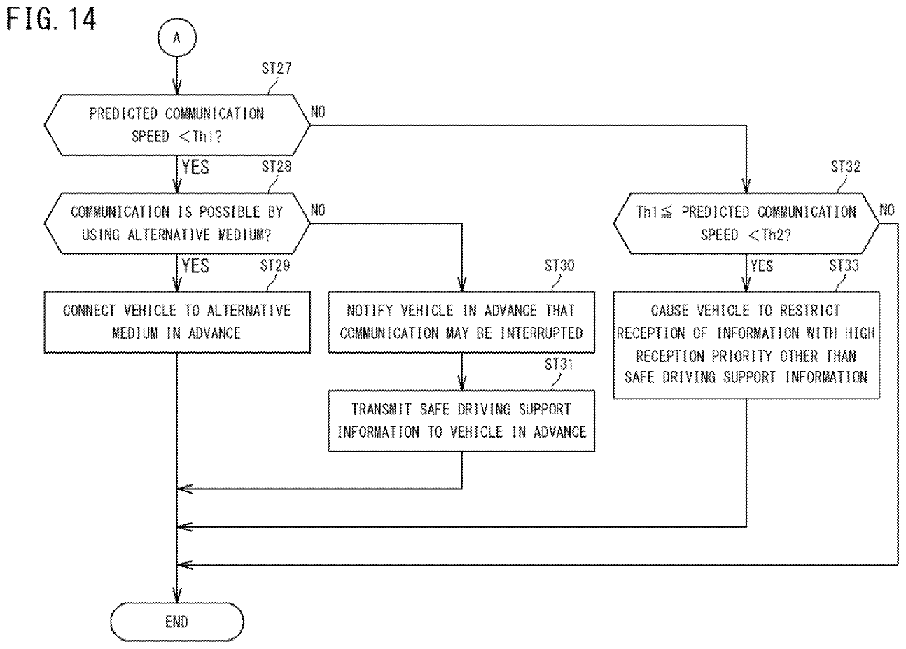

FIGS. 13 and 14 are flowcharts showing an example of the communication control processing of the radio-quiet area A23 performed by the edge server 3. As shown in FIG. 13, the edge server 3 first causes the communication unit 35 to acquire movement information and reception sensitivity information from the vehicle 5 traveling in the communication area A21 (step ST21).

The edge server 3 predicts the traveling route from the current place of the vehicle 5 from route information for navigation and map information included in the acquired movement information (step ST22).

Next, the edge server 3 acquires the reception sensitivity map M3 (cf. FIG. 10) from the storage unit 34 of its own device (step ST23).

The edge server 3 predicts the reception sensitivity of the predicted traveling route from the reception sensitivity information indicating the reception sensitivity at the current place acquired from the vehicle 5 and the reception sensitivity map M3 acquired from the storage unit 34 (step ST24). For example, the edge server 3 predicts a temporal change in reception sensitivity at the time when the vehicle 5 travels on the predicted traveling route (cf. the graph G1 in FIG. 11).

Next, the edge server 3 acquires communication speed information indicating the communication speed at the current place of the vehicle 5 (step ST25). For example, the edge server 3 can acquire the communication speed information of the current place of the vehicle 5 from the communication state at the time when the movement information and the like are acquired from the vehicle 5.

The edge server 3 predicts the communication speed of the predicted traveling route from the acquired communication speed information of the current place and the predicted reception sensitivity predicted in step ST22 (step ST26). For example, the edge server 3 predicts a temporal change in communication speed at the time when the vehicle 5 travels on the predicted traveling route (cf. graph G2 in FIG. 11).

The edge server 3 according to the present embodiment, for example, deduces that the temporal change in communication speed is similar to the temporal change in reception sensitivity and multiplies the communication speed at the current place by the same change rate as the reception sensitivity to calculate the communication speed of the traveling route.

As shown in FIG. 14, next, the edge server 3 determines whether or not the predicted communication speed predicted in step ST26 is less than the first threshold Th1 (cf. FIG. 9) (step ST27). That is, the edge server 3 determines whether or not the predicted traveling route includes the radio-quiet area A23 in which the predicted communication speed is less than the first threshold Th1.

When the determination result in step ST27 is positive, the edge server 3 determines that the vehicle 5 cannot receive the safe driving support information when traveling in the radio-quiet area A23 in the current communication medium (5G communication), and the processing shifts to the determination of step ST28.

In step ST28, the edge server 3 determines whether or not communication is possible by connecting the vehicle 5 to an alternative communication medium other than the current communication medium (step ST28).

This determination can be made, for example, based on any of the following information.
1) Positional information of the base station of the alternative communication medium, prepared in advance
2) Positional information of the base station of the alternative communication medium, acquired in advance by the communication of the alternative communication medium
3) When the alternative communication medium is vehicle-to-vehicle communication, information predicting in advance whether or not another vehicle 5 performing the vehicle-to-vehicle communication travels in the vicinity of the radio-quiet area A23

If the determination result in step ST28 is positive, the edge server 3 connects the vehicle 5 to the alternative communication medium in advance before the vehicle 5 reaches the radio-quiet area A23 (step ST29). Thereby, the vehicle 5 can receive the safe driving support information from the edge server 3 without an interruption by using the alternative communication medium when traveling in the radio-quiet area A23. It is thus possible to reliably provide the safe movement support information to the vehicle 5 traveling in the radio-quiet area A23.

After the vehicle 5 has passed through the radio-quiet area A23, the communication is returned from the alternative communication medium to the wireless communication using the normal communication medium (here, 5G communication).

On the other hand, when the determination result in step ST28 is negative, the edge server 3 notifies the vehicle 5 in advance that there is a possibility of an interruption in the wireless communication, before the vehicle 5 reaches the radio-quiet area A23 (step ST30). Thereby, the vehicle 5 can easily learn that it may not be possible to receive the safe movement support information in the radio-quiet area A23.

Further, the edge server 3 transmits the safe driving support information to the vehicle 5 in advance before the vehicle 5 reaches the radio-quiet area A23 (step ST31). The safety support information to be transmitted in advance includes, for example, signal information of a signal two cycles (usually one cycle before) before the intersection and approach information of other vehicles approaching the own vehicle within a 100 m (usually within 50 m)-distance.

The vehicle 5 can thus acquire the safe movement support information in advance before reaching the radio-quiet area A23, so that it is possible to reliably provide the safe movement support information to the vehicle 5 traveling in the radio-quiet area A23. As a result, the vehicle 5 can perform autonomous safe driving support control based on the safe driving support information acquired in advance when traveling in the radio-quiet area A23.

After the vehicle 5 has passed the radio-quiet area A23, the edge server 3 returns to the normal communication control.

In step ST27, when the determination result is negative, the edge server 3 determines whether or not the predicted communication speed of the predicted traveling route is equal to or more than the first threshold Th1 and less than the second threshold Th2 (cf. FIG. 9) (step ST32). That is, the edge server 3 determines whether or not the predicted traveling route includes the radio-quiet area A23 in which the predicted communication speed is less than the first threshold Th1 and less than the second threshold Th2.

When the determination result in step ST32 is positive, the edge server 3 determines that the vehicle 5 may not be able to receive the safe driving support information at the time of traveling in the radio-quiet area A23 if the vehicle 5 preferentially receives the information with a high reception priority other than the safe driving support information, and the edge server 3 performs the processing of step ST33.

In step ST33, the edge server 3 controls the wireless communication of the vehicle 5 so as to restrict the reception of the information with a high reception priority other than the safe driving support information when the vehicle 5 travels in the radio-quiet area A23. Thereby, it is possible to reliably provide the safe movement support information to the vehicle 5 traveling in the radio-quiet area A23.

After the vehicle 5 has passed the radio-quiet area A23, the edge server 3 cancels the reception restriction of the information with a high reception priority and returns to the normal communication control.

On the other hand, when the determination result of step ST32 is negative, the edge server 3 determines that the radio-quiet area A23 is not included in the predicted traveling route, and ends the processing.

### [Others]

In the communication control device of the present embodiment, the 5G communication has been used as the communication medium to which the vehicle 5 normally connects, but the present invention can also be applied to a case where another communication medium such as the LTE standard is used. Moreover, although the wireless communication of the vehicle 5 has been controlled in the communication control device of the present embodiment, the wireless communication of the pedestrian terminal 70 may be controlled.

Although the edge server 3 has functioned as the communication control device in the present embodiment, the core server 4 may function as the communication control device, and the vehicle 5 or the pedestrian terminal 70, which is a mobile terminal, may function as the communication control device. In the latter case, the vehicle 5 (or the pedestrian terminal 70) may only acquire the reception sensitivity map (reception sensitivity distribution information), created by the edge server 3, by using the communication unit 61 (or the communication unit 75).

The embodiment disclosed herein should be considered as illustrative and non-restrictive in every respect. The scope of the present invention is illustrated not by the meaning described above but by the scope of the claims, and is intended to include the meanings equivalent to the scope of the claims and all modifications within the scope.

### REFERENCE SIGNS LIST

1A: COMMUNICATION TERMINAL
1B: COMMUNICATION TERMINAL
1C: COMMUNICATION TERMINAL
1D: COMMUNICATION TERMINAL
2: BASE STATION
3: EDGE SERVER (COMMUNICATION CONTROL DEVICE)
4: CORE SERVER
5: VEHICLE (MOBILE TERMINAL)
7: PEDESTRIAN
8: ROADSIDE SENSOR (FIXED TERMINAL)
9: TRAFFIC SIGNAL CONTROLLER
21: MACRO-CELL BASE STATION
22: SMALL CELL BASE STATION
31: CONTROL UNIT
32: ROM
33: RAM
34: STORAGE UNIT (ACQUISITION UNIT)
35: COMMUNICATION UNIT
41: CONTROL UNIT
42: ROM
43: RAM
44: STORAGE UNIT
45: COMMUNICATION UNIT
50: IN-VEHICLE DEVICE
51: IN-VEHICLE DEVICE
52: GPS RECEIVER
53: VEHICLE SPEED SENSOR
54: GYRO SENSOR
55: STORAGE UNIT
56: DISPLAY
57: SPEAKER
58: INPUT DEVICE
59: IN-VEHICLE CAMERA
60: RADAR SENSOR
61: COMMUNICATION UNIT
70: PEDESTRIAN TERMINAL (MOBILE TERMINAL)
71: CONTROL UNIT
72: STORAGE UNIT
73: DISPLAY UNIT
74: OPERATION UNIT
75: COMMUNICATION UNIT
81: CONTROL UNIT
82: STORAGE UNIT
83: ROADSIDE CAMERA
84: RADAR SENSOR
85: COMMUNICATION UNIT
311: MAP CREATION UNIT
312: PREDICTION UNIT
313: COMMUNICATION CONTROL UNIT
A21: COMMUNICATION AREA
Ap21: PARTIAL AREA
A22: COMMUNICATION AREA
A23: RADIO-QUIET AREA
M3: RECEPTION SENSITIVITY MAP (RECEPTION SENSITIVITY DISTRIBUTION INFORMATION)
Th1: FIRST THRESHOLD
Th2: SECOND THRESHOLD

1. A communication control device for controlling wireless communication of a mobile terminal, the device comprising:
an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predicable;
a prediction unit that predicts the moving route based on the movement information and predicts a communication speed of the mobile terminal on the predicted moving route based on the reception sensitivity distribution information; and
a communication control unit that controls the wireless communication of the mobile terminal based on the predicted communication speed predicted by the prediction unit.

2. The communication control device according to claim 1, wherein, when the predicted moving route includes a radio-quiet area in which the predicted communication speed is less than a first threshold defined below, the communication control unit connects the mobile terminal to an alternative communication medium before the mobile terminal reaches the radio-quiet area;
wherein the first threshold is a minimum required communication speed for the mobile terminal to receive safe movement support information.

3. The communication control device according to claim 1, wherein, when the predicted moving route includes a radio-quiet area in which the predicted communication speed is less than a first threshold defined below, the communication control unit notifies the mobile terminal that there is a possibility of an interruption in the wireless communication, before the mobile terminal reaches the radio-quiet area;
wherein the first threshold is a minimum required communication speed for the mobile terminal to receive safe movement support information.

4. The communication control device according to claim 1, wherein, when the predicted moving route includes a radio-quiet area in which the predicted communication speed is less than a first threshold defined below, the communication control unit controls the wireless communication of the mobile terminal so that the mobile terminal is able to receive the safe movement support information before the mobile terminal reaches the radio-quiet area;
wherein the first threshold a minimum required communication speed for the mobile terminal to receive safe movement support information.

5. The communication control device according to claim 1, wherein, when the predicted moving route includes a radio-quiet area in which the predicted communication speed is equal to or more than a first threshold defined below and less than a second threshold defined below, the communication control unit controls the wireless communication of the mobile terminal so that the mobile terminal restricts reception of information with a high reception priority when moving in the radio-quiet area;
wherein the first threshold is a minimum required communication speed for the mobile terminal to receive safe movement support information;
wherein the second threshold a minimum required communication speed for the mobile terminal to receive safe movement support information and other information with a high reception priority.

6. A communication control method for wireless communication of a mobile terminal, the method comprising:
an acquisition step of acquiring reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable;
a prediction step of predicting the moving route based on the movement information and predicting a communication speed of the mobile terminal on the predicted moving route based on the reception sensitivity distribution information; and
a communication control step of controlling the wireless communication of the mobile terminal based on the predicted communication speed predicted in the prediction step.

7. A non-transitory computer readable storage medium storing a computer program for causing a computer to perform processing of controlling wireless communication of a mobile terminal, the computer program causing the computer to function as:
an acquisition unit that acquires reception sensitivity distribution information indicating reception sensitivity for each of a plurality of partial areas into which a communication area of a base station is divided, the base station communicating wirelessly with the mobile terminal, and acquires movement information with which a moving route of the mobile terminal is predictable;
a prediction unit that predicts the moving route based on the movement information and predicts a communication speed of the mobile terminal on the predicted moving route based on the reception sensitivity distribution information; and
a communication control unit that controls the wireless communication of the mobile terminal based on the predicted communication speed predicted by the prediction unit.
